(19) United States
(12) Patent Application Publication
(10) Pub. No.: US 2025/0382175 A1
(43) Pub. Date: Dec. 18, 2025

(54) METHOD FOR PRODUCING HIGH-PURITY PHOSPHORIC ACID USING QUANTUM COUPLING OF PHOSPHORIC ACID

(71) Applicant: RAM TECHNOLOGY CO., LTD., Yongin-si (KR)

(72) Inventors: June Ing KIL, Seoul (KR); Jeong Jun Park, Seoul (KR); Young Su Jang, Hwaseong-si (KR); Min Kyu Choi, Yongin-si (KR); Ji Hyeon Park, Yongin-si (KR); Ji Hoon Heo, Paju-si (KR)

(73) Assignee: RAM TECHNOLOGY CO., LTD., Yongin-si (KR)

(21) Appl. No.: 19/235,749

(22) Filed: Jun. 12, 2025

(30) Foreign Application Priority Data
Jun. 12, 2024 (KR) 10-2024-0076605

(51) Int. Cl. C01B 25/234; B01D 9/00

(52) U.S. Cl. CPC C01B 25/2346; B01D 9/0004; B01D 2009/0086

(57) ABSTRACT

The present disclosure relates to a method for producing high-purity phosphoric acid from low-purity phosphoric acid by forming pure phosphoric acid crystals using crystallization purification through quantum coupling of phosphoric acid. In particular, the present disclosure relates to a method for producing phosphoric acid capable of obtaining high-purity phosphoric acid from low-grade phosphoric acid economically and industrially by obtaining pure crystals from a phosphoric acid raw material containing a large amount of impurities through activating quantum coupling of phosphoric acid at a temperature above zero (0° C. or higher).

### TECHNICAL FIELD

The present disclosure relates to a method for producing high-purity phosphoric acid from low-purity phosphoric acid by forming pure phosphoric acid crystals using crystallization purification through quantum coupling of phosphoric acid. In particular, the present disclosure relates to a method for producing phosphoric acid capable of obtaining high-purity phosphoric acid from low-grade phosphoric acid economically and industrially by obtaining pure crystals from a phosphoric acid raw material containing a large amount of impurities through activating quantum coupling of phosphoric acid at a temperature above zero (0° C. or higher).

### BACKGROUND ART

Phosphoric acid is an essential chemical material in a semiconductor manufacturing process as an only substance capable of wet-etching a semiconductor silicon nitride film (Si₃N₄, SiN). In such a silicon nitride film etching process, impurities in the phosphoric acid etchant directly affect semiconductor yield and defect occurrences, and therefore, the concentration is strictly controlled.

Since high-purity phosphoric acid usable in such a semiconductor manufacturing process may only be produced through a dry method of extracting yellow phosphorous (P4) from high-quality phosphorite and oxidizing and burning the yellow phosphorous at a high temperature of 200° C. or higher, a lot of process cost is required.

In addition, due to the limited reserves of high-quality phosphorite, depletion of the mineral is accelerated, and this causes a problem of continuously increasing the price of high-purity phosphoric acid, leading to an economical problem of increasing a semiconductor manufacturing cost.

As an existing method for purifying phosphoric acid containing a large amount of metal ion impurities, various methods such as a film separation method, an ion exchange method or a liquid extraction method have been proposed.

First, the film separation method has advantages of high yield and purity of collected phosphoric acid, but has disadvantages of high film separation process cost and very complicated operation method. In addition, there may be a safety issue for the used film due to the corrosiveness of phosphoric acid.

The ion exchange method uses an ion exchange resin or calcium zeolite to remove an acid, and since the ion exchange resin used herein has low ion exchange capacity, only an acid with low concentration may be treated, and since the ion exchange resin after completing ion exchange needs to be continuously replaced, there is a limit of incurring continuous process cost.

The liquid extraction method has advantages in that the process may be continuously operated and the devices are inexpensive, but has a disadvantage in that high-purity phosphoric acid at a level required for a semiconductor process is not able to be obtained.

A crystallization method is a method of forming crystals from a saturated solution by controlling nucleation and crystal growth rates of crystals.

The crystallization method may be divided into a method of crystallization using a phosphoric acid seed for facilitating nucleation of crystals, and a method of crystallization not using a phosphoric acid seed. When a phosphoric acid seed is not used, the crystallization condition needs to be controlled to a temperature of 40° C. below zero or lower to proceed with crystallization, causing a problem of requiring a lot of cost and time to form crystals.

Accordingly, there is a demand for the development of a new method for producing phosphoric acid capable of obtaining high-purity phosphoric acid that does not include unnecessary metals economically and industrially by separating impurities from a phosphoric acid raw material containing a lot of impurities.

### DISCLOSURE

### Technical Problem

The present disclosure is directed to providing a preparation method capable of separating and purifying high-purity phosphoric acid from low-grade phosphoric acid by controlling quantum coupling energy of phosphoric acid.

According to the present disclosure, in order to form phosphoric acid crystals without using a seed, the crystallization condition needs to be controlled so that quantum coupling of phosphoric acid is activated to perform crystallization at a temperature above zero (0° C. or higher). High-purity phosphoric acid may be obtained economically and industrially using the method for purifying phosphoric acid of the present disclosure.

### Technical Solution

One embodiment of the present disclosure provides a method for producing high-purity phosphoric acid, the method including the steps of: supplying a phosphoric acid raw material containing impurities to a cooling device at 5° C. to 50° C. (S1); and forming phosphoric acid crystals by stirring the phosphoric acid raw material (S2), wherein the cooling device has roughness adjusted so that a contact angle of the inner wall surface with respect to water is 50° or less.

The cooling device may have a contact angle of the inner wall surface of 6° or greater with respect to water.

The step of forming phosphoric acid crystals (S2) may be performed at 0° C. or higher.

The step of forming phosphoric acid crystals (S2) may be performed while cooling the cooling device to 0° C. to 15° C.

In step (S2), a cooling rate of the cooling device may be from 0.1° C./min to 5° C./min.

In the step of forming phosphoric acid crystals (S2), a stirring rate of the phosphoric acid raw material may be from 50 rpm to 600 rpm.

The cooling device may have roughness adjusted so that a surface area of the inner wall surface increases by 7% to 29%.

The cooling device may have roughness adjusted so that a vertex angle of the inner wall surface is from 23° to 74°.

The method for producing high-purity phosphoric acid of the present disclosure may further include, after the step of forming phosphoric acid crystals (S2), partially melting some of the crystallized phosphoric acid by raising the temperature of the cooling device to 20° C. to 35° C. (S3).

The method for producing high-purity phosphoric acid of the present disclosure may further include, after separating the partially melted phosphoric acid, obtaining phosphoric acid crystals not melted in the partially melting step (S3) by raising the temperature of the cooling device to 40° C. or higher (S4).

The phosphoric acid raw material may have a concentration of 88% to 91.6%.

In the phosphoric acid raw material, a total content of the impurities including Al, Ni and Fe may be 300 ppb or greater.

The phosphoric acid obtained using the above-described method may include Al, Ni and Fe each in an amount of 1 ppb or less.

### Advantageous Effects

When high-purity phosphoric acid is produced through a purification method using phosphoric acid quantum coupling provided in the present disclosure, high-purity phosphoric acid may be produced economically and industrially.

### BEST MODE

Unless defined otherwise in the present specification, all technical terms and scientific terms have the same meaning as meanings commonly understood by those skilled in the art. Terms used for the description in the present disclosure are only to effectively describe specific embodiments and are not intended to limit the present disclosure.

Singular forms used in the present specification include plural forms as well, unless the context clearly indicates otherwise.

The term ‘include’ used in the present specification specifies specific features, areas, integers, steps, operations, elements and/or components, and does not exclude the presence or addition of other specific features, areas, integers, steps, operations, elements, components and/or groups.

The present disclosure may have various modifications applied thereto, and may have various forms, and specific embodiments will be illustrated and described in detail below. However, this is not intended to limit the present disclosure to specific disclosed forms, and needs to be construed as including all modifications, equivalents and substitutes included in the idea and the technical scope.

In the present specification, when a positional relationship between two parts is described as, for example, ‘˜on’, ‘˜in an upper portion of’, ‘˜in a lower portion of’, ‘˜next to’ and the like, one or more other parts may be located between the two parts unless an expression such as ‘right’ or ‘directly’ is used.

In the present specification, when a temporal relationship is described as, for example, ‘˜after’, ‘˜subsequent to’, ‘˜then’, ‘˜prior to’ and the like, cases that where operations are not continuous may also be included unless an expression such as ‘immediately’ or ‘directly’ is used.

In the present specification, the term ‘at least one’ needs to be construed as including all combinations presentable from one or more related items.

Hereinafter, a method for producing high-purity phosphoric acid according to specific embodiments of the present disclosure will be described in more detail.

According to one embodiment of the present disclosure, there is provided a method for producing high-purity phosphoric acid, the method including the steps of: supplying a phosphoric acid raw material containing impurities to a cooling device at 5° C. to 50° C. (S1); and forming phosphoric acid crystals by stirring the phosphoric acid raw material (S2), wherein the cooling device has roughness adjusted so that a contact angle of the inner wall surface with respect to water is 50° or less.

As described above, a method of crystallization through cooling is well known in the related art as a method for purifying phosphoric acid, however, when a phosphoric acid seed is not used, the crystallization condition needs to be controlled to a temperature of 40° C. below zero or lower to proceed with crystallization, causing a problem of requiring a lot of cost and time to form crystals.

Accordingly, the inventors of the present disclosure have identified that, when roughness of an inner wall surface of a cooling device is adjusted to a certain level, crystallization may proceed at a temperature above zero (0° C. or higher) without using a phosphoric acid seed, obtaining high-purity phosphoric acid on an economical and industrial scale, and have completed the present disclosure.

According to the present disclosure, when the method includes the steps of supplying a phosphoric acid raw material containing impurities to a cooling device at 5° C. to 50° C. (S1); and forming phosphoric acid crystals by stirring the phosphoric acid raw material (S2), and the cooling device has roughness adjusted so that a contact angle of the inner wall surface of the cooling device with respect to water is 50° or less, quantum coupling is activated through a change in the quantum coupling energy of phosphoric acid, and as a result, phosphoric acid is crystallized at a temperature above zero (0° C. or higher), obtaining high-purity phosphoric acid with an excellent yield.

First, as the phosphoric acid raw material, commercially available low-purity (industrial-grade) phosphoric acid may be purchased and used, or phosphoric acid used in a semiconductor cleaning process may be collected and used. However, in terms of resource recycling, it is preferred to collect and use impurity-containing phosphoric acid used in a semiconductor process.

In the method for producing high-purity phosphoric acid of the present disclosure, a phosphoric acid raw material containing a large amount of impurities is supplied to a cooling device at 5° C. to 50° C., and then phosphoric acid crystals are formed while stirring the phosphoric acid raw material. Herein, when roughness of the inner wall surface of the cooling device is adjusted so that a contact angle of the inner wall surface with respect to water is 50° or less, quantum coupling is activated through a change in the quantum coupling energy of phosphoric acid, and the phosphoric acid crystallization may proceed at a temperature above zero (0° C. or higher).

When adjusting roughness of an inner wall surface of the cooling device, unevenness of the cooling device surface increases. Such an increase in the unevenness leads to a decrease in the vertex angle, and a decrease in the contact angle caused by an increase in the surface energy of the cooling device. First, the contact surface area between the phosphoric acid and the cooling device increases due to the decrease in the vertex angle, and accordingly, a heat exchange area of the phosphoric acid and a phosphoric acid crystal nucleation site increase, lowering nucleation energy required for a nucleation process, which is an initial stage for forming and growing phosphoric acid crystals, and as a result, phosphoric acid crystals may be formed at a temperature above zero (0° C. or higher) by activating quantum coupling of phosphoric acid. Together with the change in the vertex angle, the contact angle decreases by an increase in the surface energy of the cooling device surface. Such a decrease in the contact angle increases the time during which phosphoric acid stays at the nucleation site, and as the time during which phosphoric acid stays at the nucleation site becomes longer, nucleation proceeds faster and more nuclei are formed. In addition thereto, many phosphoric acid crystals grow rapidly from the large amount of nuclei formed as above. Increases in the numbers and the rates of nucleation and crystal growth are affected by an increase in the phosphoric acid saturation at the nucleation site. It is considered that, by adjusting roughness of the cooling device surface as above, energy required for phosphoric acid crystal nuclei and crystal formation is controlled through activating quantum coupling of phosphoric acid, and as a result, crystallization proceeds without lowering the temperature to a temperature below zero.

In other words, when stirring a phosphoric acid raw material in a cooling device of which roughness is adjusted so that a contact angle of the inner wall surface with respect to water is 50° or less while lowering a temperature inside the cooling device, nuclear particles of the phosphoric acid crystals formed by cooling even at a temperature above zero (0° C. or higher) are in favorable contact with the phosphoric acid raw material, increasing the size of the crystals, and as a result, crystallization may be achieved even at a temperature above zero.

The cooling device may have a contact angle of the inner wall surface with respect to water of 50° or less, and when the contact angle of the inner wall surface of the cooling device with respect to water is greater than 50°, there may be a problem in that phosphoric acid is not crystallized at a temperature above zero.

The cooling device may have a contact angle of the inner wall surface with respect to water of 6° or greater, and when the contact angle of the inner wall surface of the cooling device with respect to water is less than 6°, there may be a problem in that phosphoric acid is not crystallized at a temperature above zero.

The contact angle of the inner wall surface of the cooling device with respect to water may be measured through a contact angle measuring device (Phoenix MT, SEO).

The cooling device may have roughness adjusted so that a surface area of the inner wall surface increases by 7% to 29%.

The change in the surface area may be measured by a change in the water-filling volume up to a certain height of the cooling device before and after adjusting the roughness.

The cooling device may have roughness adjusted so that a vertex angle of the inner wall surface is 23° to 74°.

The vertex angle may be measured through FE-SEM (JEOL JSM-7610F).

The step of forming phosphoric acid crystals (S2) may be performed at 0° C. or higher.

Specifically, the step of forming phosphoric acid crystals (S2) may be performed by, after supplying a phosphoric acid raw material containing impurities to a cooling device at about 5° C. to 50° C., cooling the cooling device to 0° C. to 15° C.

The cooling rate of the cooling device may be from 0.1° C./min to 5° C./min, and cooling at the above-mentioned rate is appropriate for removing impurities in the phosphoric acid raw material and obtaining high-purity phosphoric acid.

In the method for producing high-purity phosphoric acid of the present disclosure, a phosphoric acid raw material containing impurities is supplied to a cooling device at 5° C. to 50° C., and then the phosphoric acid raw material is stirred and cooled at the same time to form phosphoric acid crystals. Herein, the stirring rate of the phosphoric acid raw material may be from 50 rpm to 600 rpm.

By stirring the phosphoric acid raw material at a certain rate or higher in the step of forming phosphoric acid crystals (S2), nuclear particles of the crystals formed by cooling are in favorable contact with the phosphoric acid raw material, increasing the size of the crystals, and shortening the time taken for crystallization at the same time.

When the stirring rate is less than 50 rpm, there may be a problem in that crystallization does not proceed, and when the stirring rate is greater than 600 rpm, there may be a problem in that crystals are not able to grow, resulting in a decrease in the crystallization yield.

The method for producing high-purity phosphoric acid of the present disclosure may further include, after the step of forming phosphoric acid crystals (S2), partially melting some of the crystallized phosphoric acid by raising the temperature of the cooling device to 20° C. to 35° C. (S3).

Phosphoric acid crystallized by the crystallization process may include pure phosphoric acid with almost no impurities inside the crystal and phosphoric acid containing impurities mixed thereto on the crystal surface.

Accordingly, by raising the temperature of the crystallized phosphoric acid to 20° C. to 35° C. to partially melt some of the phosphoric acid crystal surface, impurities attached to the surface may be removed, and phosphoric acid with higher purity may be obtained.

After that, the partially melted phosphoric acid is separated, and then phosphoric acid crystals not melted in the partially melting step (S3) may be obtained by raising the temperature of the cooling device to 40° C. or higher (S4).

The phosphoric acid raw material before the purification includes a large amount of impurities, and for example, the total content of impurities including Al, Ni and Fe may be 300 ppb or greater in the phosphoric acid raw material.

More specifically, the total content of impurities including 150 ppb or greater of Al, 20 ppb or greater of Ni and 100 ppb or greater of Fe may be 300 ppb or greater in the phosphoric acid raw material.

As described above, high-purity phosphoric acid may be obtained economically and industrially using the method for producing high-purity phosphoric acid of the present disclosure, and specifically, the phosphoric acid obtained using the method may include Al, Ni and Fe each in an amount of 1 ppb or less.

Hereinafter, embodiments of the present disclosure will be described in more detail with reference to the following examples. However, the following examples are just for illustrating embodiments of the present disclosure, and the present disclosure is not limited by the following examples.

### Identification of Crystallization at Room Temperature

### (1) Example 1

First, a 91.6% phosphoric acid raw material (1,000 g) including impurities was supplied to a cooling device at 35° C. For the cooling device, roughness was adjusted so that the contact angle of the inner wall surface with respect to water is 6°, the vertex angle is 23°, and the surface area increases by 7%.

After that, the cooling device was cooled from 35° C. to 5° C. at a rate of 0.5° C./min while stirring the phosphoric acid raw material at a rate of 50 rpm, and then phosphoric acid crystallization was performed for 1 hour.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (807 g) was obtained.

### (2) Example 2

Phosphoric acid crystallization was performed in the same manner as in Example 1, except that the concentration of the phosphoric acid raw material was 88%.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (738 g) was obtained.

### (3) Example 3

Phosphoric acid crystallization was performed in the same manner as in Example 1, except that the phosphoric acid raw material was stirred at a rate of 600 rpm.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (758 g) was obtained.

### (4) Example 4

Phosphoric acid crystallization was performed in the same manner as in Example 1, except that roughness was adjusted so that the surface area of the cooling device increased by 29%.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (848 g) was obtained.

### (5) Example 5

Phosphoric acid crystallization was performed in the same manner as in Example 1, except that the cooling rate was controlled to 0.1° C./min.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (812 g) was obtained.

### (6) Example 6

Phosphoric acid crystallization was performed in the same manner as in Example 1, except that the cooling rate was controlled to 5° C./min.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (835 g) was obtained.

### (7) Example 7

Phosphoric acid crystallization was performed in the same manner as in Example 1, except that the temperature of the cooling device was controlled to 50° C. when introducing the phosphoric acid raw material.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (799 g) was obtained.

### (8) Example 8

Phosphoric acid crystallization was performed in the same manner as in Example 1, except that the temperature of the cooling device was controlled to 5° C. when introducing the phosphoric acid raw material.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (863 g) was obtained.

### (9) Example 9

Phosphoric acid crystallization was performed in the same manner as in Example 1, except that the cooling temperature was controlled to 0° C.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (859 g) was obtained.

### (10) Example 10

Phosphoric acid crystallization was performed in the same manner as in Example 1, except that the cooling temperature was controlled to 15° C.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (766 g) was obtained.

### (11) Example 11

Phosphoric acid crystallization was performed in the same manner as in Example 1, except that the contact angle of the inner wall surface of the cooling device with respect to water was controlled to 50°.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (774 g) was obtained.

### (12) Example 12

Phosphoric acid crystallization was performed in the same manner as in Example 1, except that the vertex angle of the inner wall surface of the cooling device was controlled to 74°.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (751 g) was obtained.

### (13) Comparative Example 1

A 91.6% phosphoric acid raw material (1,000 g) including impurities was supplied to a cooling device at 35° C. Herein, for the cooling device, roughness was adjusted so that a contact angle of the inner wall surface with respect to water is 60°, the vertex angle is 23°, and the surface area increases by 7%.

After that, the cooling device was cooled from 35° C. to 5° C. at a rate of 0.5° C./min while stirring the phosphoric acid raw material at a rate of 50 rpm, and then crystallization of the phosphoric acid was performed for 1 hour.

As a result of performing the crystallization, the phosphoric acid raw material was not crystallized.

### (14) Comparative Example 2

Phosphoric acid crystallization was performed in the same manner as in Example 1, except that the phosphoric acid raw material was stirred at a rate of 1,000 rpm.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (89 g) was obtained.

### (15) Comparative Example 3

Phosphoric acid crystallization was performed in the same manner as in Example 1, except that roughness of the cooling device surface was not adjusted.

As a result of performing the crystallization, the phosphoric acid raw material was not crystallized.

### (16) Comparative Example 4

Phosphoric acid crystallization was performed in the same manner as in Example 1, except that the cooling rate of the phosphoric acid raw material was 10° C./min.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (828 g) was obtained.

### (17) Comparative Example 5

Phosphoric acid crystallization was performed in the same manner as in Example 1, except that the temperature of the cooling device was controlled to 70° C. when introducing the phosphoric acid raw material.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (138 g) was obtained.

### (18) Comparative Example 6

Phosphoric acid crystallization was performed in the same manner as in Example 1, except that the cooling temperature was controlled to 30° C.

As a result of performing the crystallization, the phosphoric acid raw material was not crystallized.

### (19) Comparative Example 7

Phosphoric acid crystallization was performed in the same manner as in Example 1, except that the contact angle of the inner wall surface of the cooling device with respect to water was controlled to 90°.

As a result of performing the crystallization, the phosphoric acid raw material was not crystallized.

### (20) Comparative Example 8

Phosphoric acid crystallization was performed in the same manner as in Example 1, except that roughness was controlled so that the surface area of the cooling device increased by 43%.

Phosphoric acid that was not crystallized was removed, and some of the crystallized phosphoric acid was partially melted and separated by raising the temperature of the cooling device to 20° C.

The remaining phosphoric acid crystals not melted were all melted by raising the temperature to 40° C. or higher, and finally purified crystallized phosphoric acid (818 g) was obtained.

### Analysis on Metal Impurity Content in Crystallized Phosphoric Acid

For each of the phosphoric acid raw material, the non-crystallized phosphoric acid, the phosphoric acid partially melted and separated, and the crystallized phosphoric acid obtained by raising the temperature to 40° C. or higher, the content of metal impurities in the phosphoric acid was analyzed using ICP-MS.

Specifically, the non-crystallized phosphoric acid, the partially melted phosphoric acid, and the crystallized phosphoric acid were each diluted with DIW or 3% nitric acid using Agilent ICP-MS 8900 to analyze the metal impurity content in the sample.

TABLE 1

| | | Example 1 | | Example 2 | | Example 3 | | Example 4 | |
|---|---|---|---|---|---|---|---|---|---|
| | | Non- | | Non- | | Non- | | Non- | |
| | | crystal- | | crystal- | | crystal- | | crystal- | |
| | | lized + | | lized + | | lized + | | lized + | |
| | Phos- | Partially | Crystal- | Partially | Crystal- | Partially | Crystal- | Partially | Crystal- |
| | phoric | Melted | lized | Melted | lized | Melted | lized | Melted | lized |
| | Acid | Phos- | Phos- | Phos- | Phos- | Phos- | Phos- | Phos- | Phos- |
| | Raw | phoric | phoric | phoric | phoric | phoric | phoric | phoric | phoric |
| | Material | Acid | Acid | Acid | Acid | Acid | Acid | Acid | Acid |
| Al (ppb) | 311 | 1284 | 0.71 | 1013 | 0.74 | 993 | 0.75 | 1488 | 0.75 |
| Ni (ppb) | 38 | 143 | 0.66 | 104 | 0.80 | 127 | 0.72 | 184 | 0.81 |
| Fe (ppb) | 231 | 843 | 0.69 | 658 | 0.67 | 721 | 0.61 | 1102 | 0.74 |

TABLE 2

| | | Example 5 | | Example 6 | | Example 7 | | Example 8 | |
|---|---|---|---|---|---|---|---|---|---|
| | | Non- | | Non- | | Non- | | Non- | |
| | | crystal- | | crystal- | | crystal- | | crystal- | |
| | | lized + | | lized + | | lized + | | lized + | |
| | Phos- | Partially | Crystal- | Partially | Crystal- | Partially | Crystal- | Partially | Crystal- |
| | phoric | Melted | lized | Melted | lized | Melted | lized | Melted | lized |
| | Acid | Phos- | Phos- | Phos- | Phos- | Phos- | Phos- | Phos- | Phos- |
| | Raw | phoric | phoric | phoric | phoric | phoric | phoric | phoric | phoric |
| | Material | Acid | Acid | Acid | Acid | Acid | Acid | Acid | Acid |
| Al (ppb) | 311 | 1205 | 0.64 | 1405 | 0.81 | 1321 | 0.68 | 1688 | 0.86 |
| Ni (ppb) | 38 | 149 | 0.58 | 201 | 0.82 | 155 | 0.73 | 215 | 0.92 |
| Fe (ppb) | 231 | 865 | 0.54 | 1166 | 0.79 | 901 | 0.71 | 1365 | 0.84 |

TABLE 3

| | | Example 9 | | Example 10 | | Example 11 | | Example 12 | |
|---|---|---|---|---|---|---|---|---|---|
| | | Non- | | Non- | | Non- | | Non- | |
| | | crystal- | | crystal- | | crystal- | | crystal- | |
| | | lized + | | lized + | | lized + | | lized + | |
| | Phos- | Partially | Crystal- | Partially | Crystal- | Partially | Crystal- | Partially | Crystal- |
| | phoric | Melted | lized | Melted | lized | Melted | lized | Melted | lized |
| | Acid | Phos- | Phos- | Phos- | Phos- | Phos- | Phos- | Phos- | Phos- |
| | Raw | phoric | phoric | phoric | phoric | phoric | phoric | phoric | phoric |
| | Material | Acid | Acid | Acid | Acid | Acid | Acid | Acid | Acid |
| Al (ppb) | 311 | 1543 | 0.94 | 1165 | 0.81 | 1094 | 0.77 | 896 | 0.74 |
| Ni (ppb) | 38 | 194 | 0.86 | 134 | 0.65 | 113 | 0.71 | 115 | 0.66 |
| Fe (ppb) | 231 | 1204 | 0.79 | 743 | 0.73 | 699 | 0.78 | 714 | 0.61 |

TABLE 4

| | | Comparative | | Comparative | | Comparative | | Comparative | |
|---|---|---|---|---|---|---|---|---|---|
| | | Example 1 | | Example 2 | | Example 3 | | Example 4 | |
| | | Non- | | Non- | | Non- | | Non- | |
| | | crystal- | | crystal- | | crystal- | | crystal- | |
| | | lized + | | lized + | | lized + | | lized + | |
| | Phos- | Partially | Crystal- | Partially | Crystal- | Partially | Crystal- | Partially | Crystal- |
| | phoric | Melted | lized | Melted | lized | Melted | lized | Melted | lized |
| | Acid | Phos- | Phos- | Phos- | Phos- | Phos- | Phos- | Phos- | Phos- |
| | Raw | phoric | phoric | phoric | phoric | phoric | phoric | phoric | phoric |
| | Material | Acid | Acid | Acid | Acid | Acid | Acid | Acid | Acid |
| Al (ppb) | 311 | 314 | — | 258 | 0.81 | 304 | — | 1221 | 23 |
| Ni (ppb) | 38 | 36 | — | 31 | 0.64 | 35 | — | 94 | 16 |
| Fe (ppb) | 231 | 221 | — | 212 | 0.73 | 216 | — | 849 | 22 |

TABLE 5

| | | Comparative | | Comparative | | Comparative | | Comparative | |
|---|---|---|---|---|---|---|---|---|---|
| | | Example 5 | | Example 6 | | Example 7 | | Example 8 | |
| | | Non- | | Non- | | Non- | | Non- | |
| | | crystal- | | crystal- | | crystal- | | crystal- | |
| | | lized + | | lized + | | lized + | | lized + | |
| | Phos- | Partially | Crystal- | Partially | Crystal- | Partially | Crystal- | Partially | Crystal- |
| | phoric | Melted | lized | Melted | lized | Melted | lized | Melted | lized |
| | Acid | Phos- | Phos- | Phos- | Phos- | Phos- | Phos- | Phos- | Phos- |
| | Raw | phoric | phoric | phoric | phoric | phoric | phoric | phoric | phoric |
| | Material | Acid | Acid | Acid | Acid | Acid | Acid | Acid | Acid |
| Al (ppb) | 311 | 283 | 0.84 | 311 | — | 310 | — | 1193 | 31 |
| Ni (ppb) | 38 | 36 | 0.95 | 34 | — | 34 | — | 63 | 26 |
| Fe (ppb) | 231 | 204 | 0.76 | 228 | — | 230 | — | 802 | 41 |

From Tables 1 to 5, it was identified that, when the method for producing high-purity phosphoric acid of the present disclosure is used. high-purity phosphoric acid that does not include unnecessary metals was able to be obtained by separating impurities from a phosphoric acid raw material containing a lot of impurities.

1. A method for producing high-purity phosphoric acid, the method comprising the steps of:
supplying a phosphoric acid raw material containing impurities to a cooling device at 5° C. to 50° C. (S1); and
forming phosphoric acid crystals by stirring the phosphoric acid raw material (S2),
wherein the cooling device has roughness adjusted so that a contact angle of the inner wall surface with respect to water is 50° or less.

2. The method of claim 1, wherein the cooling device has a contact angle of the inner wall surface of 6° or greater with respect to water.

3. The method of claim 1, wherein the step of forming phosphoric acid crystals (S2) is performed at 0° C. or higher.

4. The method of claim 1, wherein the step of forming phosphoric acid crystals (S2) is performed while cooling the cooling device to 0° C. to 15° C.

5. The method of claim 4, wherein, in step (S2), a cooling rate of the cooling device is from 0.1° C./min to 5° C./min.

6. The method of claim 1, wherein, in the step of forming phosphoric acid crystals (S2), a stirring rate of the phosphoric acid raw material is from 50 rpm to 600 rpm.

7. The method of claim 1, wherein the cooling device has roughness adjusted so that a surface area of the inner wall surface increases by 7% to 29%.

8. The method of claim 1, wherein the cooling device has roughness adjusted so that a vertex angle of the inner wall surface is from 23° to 74°.

9. The method of claim 1, further comprising, after the step of forming phosphoric acid crystals (S2), partially melting some of the crystallized phosphoric acid by raising the temperature of the cooling device to 20° C. to 35° C. (S3).

10. The method of claim 9, further comprising, after separating the partially melted phosphoric acid, obtaining phosphoric acid crystals not melted in the partially melting step (S3) by raising the temperature of the cooling device to 40° C. or higher (S4).

11. The method of claim 1, wherein the phosphoric acid raw material has a concentration of 88% to 91.6%.

12. The method of claim 1, wherein a total content of the impurities including Al, Ni and Fe is 300 ppb or greater in the phosphoric acid raw material.

13. The method of claim 1, wherein the phosphoric acid obtained using the method includes Al, Ni and Fe each in an amount of 1 ppb or less.
